(19) United States
(12) Patent Application Publication
(10) Pub. No.: US 2004/0122803 A1
(43) Pub. Date: Jun. 24, 2004

(54) Detect and qualify relationships between people and find the best path through the resulting social network

(76) Inventors: Byron E. Dom, Los Gatos, CA (US); Joann Ruvolo, San Jose, CA (US); Geetika Tewari, Cambridge, MA (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/323,568

(22) Filed: Dec. 19, 2002

(51) Int. Cl. G06F 7/00

(52) U.S. Cl. 707/3

(57) ABSTRACT

Disclosed is a method and structure that identifies relationships between users of a computerized network. The method extracts relationship information from databases in the network. The information includes address book information, calendar information, event information, to-do list information, journal information, and/or e-mail information. The invention evaluates the relationship information to produce relationship ratings of the users of the network. The invention determines the level of reciprocity of relations between different users; a longevity of relations between the different users; how current relations are between the different users; a frequency of relations between the different users; a level of exclusivity of relations between the different users; a level of complexity of relations between the different users; and/or a proximity of the different users.

### BACKGROUND OF THE INVENTION

1. Field of the Invention

The present invention generally relates to use of databases to detect and qualify relationships between people and find the best path through the resulting social network.

2. Description of the Related Art

One of the main drawbacks to social network analysis is that it is difficult to carry out. One research technique is to use in-person interviews, which can be very time-consuming. In one case, it took over a year to generate the social network for a single pair of individuals via interviewing. Given the dynamic nature of a social network, this technique is far too slow to be of use.

Mechanisms have been proposed to infer social networks from electronic communication. The invention is an improvement on such mechanisms, and can construct a social network based on the analysis of shared objects. The invention uses a broader set of activity metrics than other published techniques. The invention also uses types of objects (like work flows) that other techniques do not use.

### SUMMARY OF THE INVENTION

There is provided, according to one aspect of the invention a social network analysis of looking at how people interact. By being able to understand the interaction patterns between data stored in databases, it becomes possible to more quickly find who might be able to answer questions, understand the impact of organizational change initiatives, and find who serves as bridges between different parts of an organization.

Social networks and the analysis of them have been of interest for quite a while. The results of any analysis are dependent upon the social network data and the inferences drawn from that data. This invention proposes a social network dynamically built based on the interactions of individuals extracted from the records of their daily lives. These records primarily include data sources commonly found in and/or associated with Personal Information Management (PIM) systems, as well as phone logs, and proximity reports. These PIM data sources include a calendar, a to-do list, a journal, an address book, and e-mail. They are valuable sources of information because people use them to record their activities, tasks, and impressions, to organize their contacts, and to correspond. Interactions based on these activities and correspondence can be identified. Phone logs provide the phone number of the caller and the caller, and thus reveal possible interactions between the individuals associated with these phone numbers. For individuals who are tracked and choose to be tracked, the proximity records contain the encounters of those individuals detected to be within close proximity of each other.

These data sources of our daily life are primary sources of data. In addition to reflecting our current state, they provide history and even a glimpse into the future (e.g., scheduled meetings). They have been largely overlooked as a source of information.

The system of this invention extracts the raw data from these daily-life sources to detect interactions among people (e.g., how often they meet, the last time they exchanged correspondence). It then makes inferences to detect as well as to qualify relationships between them. A relationship is qualified by assigning a value to it, based on the following attributes that this invention defines for a relationship; longevity (how long have they been connected); currency (have they connected recently); frequency (how often do they connect); exclusivity (how exclusive is the connection (e.g., one-to-one vs. one-to-many, secure content)); complexity (is the connection on many levels and on specific contexts); and reciprocity (is the connection mutual or just one-way).

The invention builds a social network from these discovered relationships. Additionally, the invention calculates the shortest and best paths through the social network, given the quality of the relationships. An application of this system is to detect people in common, i.e, finding intermediary people to mediate a connection to an expert. Discovering the best path through the people in common allows good connections/relationships. Note that the best path between two people can actually be longer than the shortest path if the quality of the direct relationships comprising the path is superior.

This intention describes a system that extracts data from several daily life sources to build a social network of its users based on their interactions with others. Some aspects of this invention are providing a definition of a relationship (see attributes above), discovering that a relationship exists between two people, qualifying that relationship (i.e., defining its value) given the defined relationship attributes, dynamically building a social network based on these discovered relationships, and calculating the shortest and best paths through the social network given the quality of the relationships.

Additional aspects of this invention are its use of primary data sources, that by the definition of their function (e.g., a calendar), provide a wealth of current and accurate information, without the added burden on its users to create artificial entries. The invention can also qualify connections between people (e.g., this is a complex relationship), rather than just quantify them (e.g., a relationship exists because the parties have had n meetings). The invention can find the best path through this relationship social network, rather than just the shortest path.

Users that choose to use or are required to use a PIM system, by the nature of the entries, provide valuable information about themselves and those they interact with. Since PIMs are an integral part of many people's lives, the data in them is likely to be relevant, accurate, and current. This data provides a good basis for detecting relationships. One benefit of this invention is its ability to qualify the relationships between people by making inferences from the raw data. This knowledge of the strength of relationships mapped onto a relationship social network provides an effective communication path that benefits individuals, organizations, and even commerce.

With a social network mapped from all the individual relationship structures, individuals can quickly view their directly connected relationships as well as paths to approach others. Since the social network is weighted based on the quality of the relationships, the best path between any two individuals is easily identifiable. When other attributes, such as expertise, are mapped onto our social network, the system can be applied to other applications for locating the optimal paths to experts, for example. The social network can also be used to spread information efficiently through an organization. It can also be used as a tool for viral marketing. Additionally, by the use of articulation points, key intermediaries can be identified. An organization can use the social network to monitor inter/intra departmental communication, and institute corrections (e.g., promote external relationships) as necessary.

These features can be determined by discovering the individual's relationship attributes with the parties concerned. On an individual level, a person could use their social network to examine the characteristics of their own social network. The user has the facility to analyze the relationship results and further customize the system to his/her preferences.

The present invention is concerned with how well two parties know each other and defines several relationship attributes in an attempt to qualify a relationship. The strength of a relationship is determined on the basis of several algorithms that calculate the precise values of these relationship attributes.

The present invention outlines several methods to determine the shortest and best relationship paths between a user and any other person in the user's social network. The paths are ranked according to their overall relationship quality value and the user is provided with several ways to approach an individual in his/her social network.

The present invention is aimed toward obtaining data from sources that reflect an individual's daily activities and/or interactions (e.g., phone logs, calendar entries).

The present invention is significantly broader than conventional systems. This invention includes all data sources commonly found in and/or associated with Personal Information Management systems (address book, calendar, to-do list, journal, e-mail), as well as phone logs and proximity reports. Therefore, the invention's results will be more complete and accurate. For example, many relationships are established and fostered by e-mail. Address books, although relatively static, provide clues to the reciprocity of a relationship. The present invention, by defining the attributes of a relationship (e.g., exclusivity, reciprocity), provides an encompassing view of a relationship.

Not only does the invention detect a relationship, but also it rates the relationship based on the relationship attributes that the invention defines. The present invention also takes into account perspective, since the two parties involved in a relationship do not always have the same view of the relationship. The present invention also looks at a relationship in absolute terms and in relative terms compared to all the other relationships of the user. Because the present invention qualifies a relationship, the invention calculates the “best” path between parties, in addition to the shortest path. The present invention is also customized on a user basis.

The invention identifies relationships between users of a computerized network, by extracting relationship information from the databases in the network. The information includes address book information, calendar information, event information, to-do list information, journal information, and/or e-mail information. The invention evaluates the relationship information to produce relationship ratings of the users of the network. The invention also determines a level of reciprocity of relations between different users; determines a longevity of relations between the different users; determines how current relations are between the different users; determines a frequency of relations between the different users; determines a level of exclusivity of relations between the different users; and determines a level of complexity of relations between the different users.

The invention evaluates whether a user is a direct or indirect correspondence recipient as reflected by the address book information or the e-mail information. The invention evaluates times of events and users involved in events to establish relationships between the users. The invention also evaluates the time of day of events or e-mails to establish whether a relationship is personal or business related. The invention weights the address book information, the calendar information, the event information, the to-do list information, the journal information, and the e-mail information differently to calculate the relationship ratings. When the invention identifies relationships between users of a computerized network, the invention extracts information from address books in the network and evaluates the information to produce relationship ratings of the users of the network. The invention further identifies relationships between users of a computerized network. The invention also extracts e-mail communications information between users of the network; and evaluates the e-mail communications information to produce relationship ratings of the users of the network.

### BRIEF DESCRIPTION OF THE DRAWINGS

The invention will be better understood from the following detailed description of preferred embodiments of the invention with reference to the drawings, in which:

FIG. 1 is a schematic diagram of persistent data structures;

FIG. 2 is a schematic diagram of three components; extracting, accumulating, and evaluating;

FIG. 3 is a flow diagram of the accumulation component; and

FIG. 4 is a flow diagram of the evaluation component.

### DETAILED DESCRIPTION OF PREFERRED EMBODIMENTS OF THE INVENTION

The following data sources are commonly found in and/or associated with personal information management (PIM) systems. The first data source is the Address Book. The address book data source contains entries with contact information for people and groups. There is one entry per contact and an address book entry could conform to the vCard standard, and would contain such fields as the contact's name, address, and phone number.

In order to facilitate interoperability, a PIM system uses an object model, such as iCalendar (Internet Calendaring and Scheduling Core Object Specification standard defined in RFC2445). iCalendar defines an object model for the components of a calendar system and their associated properties. The following are considered calendar components. One component is the Event. The Event data source contains entries for the events (past, present, and future) of the users of the system. There is one entry for each event. The properties of an event are defined in detail in the iCalendar standard, though they include start time, end time, summary, description, and attendees.

The To-do data source is another component and contains entries for the tasks (past, present, and future) of the users of the system. There is one entry for each task. The properties of a to-do are defined in detail in the iCalendar standard, though they include start time, duration, description, completed, and attendees. The Journal data source is another component and contains entries for descriptive text notes associated with a particular calendar date. There is one entry for each note. The properties of a journal are defined in detail in the iCalendar standard though they include start time, description, and attendees. The e-mail data source is commonly associated with PIM systems and contains the entries for e-mails received and saved by users and, if kept, e-mail sent to users and saved drafts. The e-mail header contains fields, such as, recipients.

A relationship between two people can be defined in terms of the following attributes: longevity, currency, reciprocity, exclusivity, frequency, and complexity. The longevity refers to how long the two parties have been connected. Currency refers to the recency of the connection. Reciprocity is a function of the mutual interchange between the parties. Exclusivity is a function of the number of one-on-one interactions and the privacy of the interactions. Frequency is a measure of the rate of interactions. Complexity is a function of the levels and the context of the interactions.

The raw data of the PIM data sources named above can provide clues to detect whether a relationship between two people exists and to qualify that relationship. Events record the past, present, and future scheduled activities of people. The parties of an event (e.g., organizers and participants) indicate those involved with the activity and may also demonstrate a relationship between the parties. That is, an organizer and each participant may have a relationship. Additionally, each participant may have a relationship with each other. An event with just two participants may imply a more exclusive relationship between the participants than an event with many participants. An event with a large number of participants (as in a conference setting or a large meeting) may have no significance on the relationships among the participants. The participation role indicates whether a participant is required, optional, copied just for informational purposes, or is to chair the event. Participants who are just copied for informational purposes are less likely to attend the event and therefore may offer no significance to the quality of the relationship.

According to the iCalendar specification, To-do and Journal information are treated similarly to Events, with respect to participants. E-mail is a representation of the correspondence between people. The parties of an e-mail (e.g., senders and recipients) indicate those involved in the correspondence and may also demonstrate a relationship between the parties. That is, the sender and each recipient may have a relationship. Additionally, each recipient may have a relationship with each other. An e-mail between the sender and just one recipient may imply a more exclusive relationship between the parties than an e-mail addressed to many recipients. An e-mail with a large number of recipients (as in a mailing list) may have no significance on the relationships between the sender and recipients. The destination identifies the recipients of the e-mail, with TO containing the primary recipients, CC containing the secondary (informational) recipients, and BCC containing those recipients whose identity the sender does not wish to disclose. For each criterion used in detecting and qualifying a relationship, the following is a summary of how the relevant information extracted from the data sources can satisfy that criteria. The available data sources are analyzed to determine the earliest connection date between two people. This date may be the creation date of the address book entry for the other party, the creation or schedule date of the earliest event with the other party as a participant, the creation or due date of the earliest to-do with the other party, the creation or entry date of the earliest journal entry containing the other party, or the date of the earliest message sent to/received from the other party. The available data sources are analyzed to determine the most recent connection date between two people. This date may be the creation or last access date of the address book entry for the other party (e.g., a phone number looked up), the creation or schedule date of the most recent event with the other party as participant, the creation or due date of the most recent to-do with the other party, the date of the most recent journal entry containing the other party, or the date of the most recent message sent to/received from the other party. The available data sources are analyzed to determine how mutual the connection is between two people. This may be a function of the two-way correspondence between each other and of the mutuality of the address book entries for each other.

There are four possibilities to represent the reciprocity of address book entries, as stated below. For example, User A and User B can have mutual address book entries. User A can contain an entry in his address book for User B, and User B does not contain an entry for User A. User B may contain an entry in his address book for User A, and User A does not contain an entry for User B. Also, neither User A nor User B could contain an entry for each other in their respective address books.

Any given person's address book can be presumed to contain entries for contacts that are noteworthy to the owner at some point in time. Mutual address book entries may imply a deeper relationship between two users than if only one of the users had an entry for the other. And it may follow that a one-way relationship implies a deeper relationship than if neither user had a corresponding entry for the other.

However, one cannot conclude that just because a person does not have an address book entry for another that the contact is unknown or is not important to the address book owner. Whether a person creates an address book entry is a function of the importance he places on the contact, the convenience of creating a contact entry (e.g., a shortcut for adding the sender of an incoming e-mail to the recipient's address book), the convenience of adding contacts to new PIM entries (e.g., auto-filling contacts as recipients to outgoing e-mail), and the personality of the address book owner (e.g., a methodical person is more likely to keep his address book up to date). The absence of an address book entry may be more telling than its presence. Once an entry is created, it is rarely deleted. So indications that a relationship exists, may remain long after the relationship dies.

Reciprocity can be further refined in terms of the type of relationship, if known (e.g., an organizational relationship, such as employee/manager). The available data sources are analyzed to determine the level of exclusivity of the connection between two people. This may be a function of the proportion of events with the other party that involve just the other party and no one else, the proportion of messages sent to/received from the other party that are sent to/received from just the other party, the proportion of the messages between the two parties that are encrypted, the proportion of the events, to-dos, and journal information involving the two parties that are marked private (versus public).

Data encryption can be used to increase the privacy of an e-mail's content. However, since headers need to be accessed by mail transport services, the names, addresses, and subject remain unencrypted. Encrypted e-mails may imply a more private or confidential relationship between the originator and recipients of the e-mail.

The available data sources are analyzed to determine the level of complexity of the connection between two people. This is a measure of the various levels and contexts of the relationship. It may be a function of the number of group affiliations of the second party as noted by the first party, the number of groups indirectly associated with the second party as related to the first party, the type of their relationship (e.g., professional, personal, professional and personal), and the contexts of their relationship.

Group “affiliations” can be discovered within address books. In addition to contacts, address books may also allow group entries to be defined, with contacts listed as members. For example, an address book owner may have defined groups “team,” “friends,” and “soccer” and added the contacts that he associates with these groups to each respective group. Therefore, a listing of contacts under a specific group entry within an address book provides a context for the address book's owner's relationship with those contacts. A contact may be listed within multiple group entries; using the example above a contact may be both a “team” member and a “friend.” The more groups affiliated with a contact may imply a broader relationship with the address book owner.

Indirect group associations can be discovered from e-mail, and event, to-do, and journal information. E-mail includes recipients, while event, to-do, and journal information may include participants. When more than one party exists, it forms a group. For example, user X sends e-mail to A, B, and C. User X also sends e-mail to B, D, E, and F. In this example there are two groups; B is a member of both groups; A and C are members of the first group and D, E, and F are members of the second group. Again, a party associated with more than one group, may imply a broader relationship with the related party.

The contexts of a relationship may also be determined from the subject/category of shared e-mail, events, to-dos, and journal information. The scheduled date/time of an event or to-do can provide a clue as to the type of relationship. For example, events scheduled for the weekend or after hours may imply a more personal relationship.

The available data sources are analyzed to determine the frequency of connections between two people. Frequency also includes measures for direction, constancy, and periodicity. Frequency is a measure of how much correspondence has occurred in the relationship. Direction is an indication of whether correspondence is increasing or decreasing and by how much. Constancy is an indication of the sporadic or constant nature of the correspondence in the relationship. A high value indicates a very constant stream of correspondence over time. A low value indicates there are periods of relative high and low correspondence in the relationship. Periodicity is a relative measure of the average interval between correspondences.

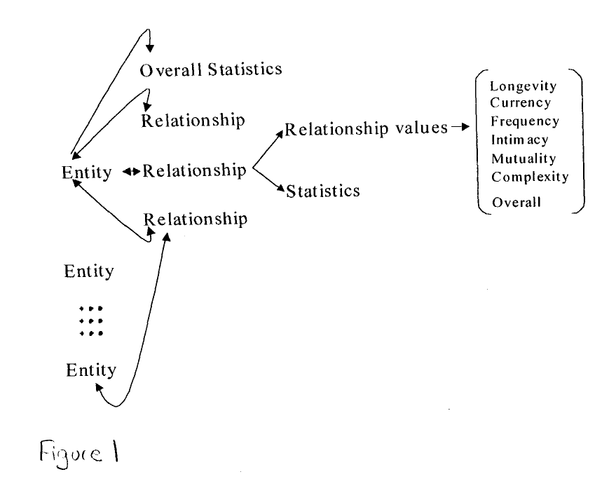

The system of this invention maintains persistent data structures. These data structures, represented in FIG. 1, comprise entities, relationships, statistics, and relationship values. An entity object represents, for example, a person of the system (e.g., a sender of e-mail). A relationship object represents a relationship between two entities (e.g., a sender and a recipient of e-mail). In order to maintain a perspective on the relationship from each person, each entity has anchored from it its relationship object for the other entity. A summary of interactions is maintained in the statistics object. The statistics object comprises fields such as the earliest interaction date, most recent interaction date, number of interactions, number of one-on-one interactions, number of encrypted interactions, number of personal interactions, number of professional interactions, number of originated, targeted, and undirected interactions. Interactions can be directed or undirected. An example of a directed interaction between two people is an e-mail sent from one person and received from another person. An example of an undirected interaction between two people is when both are co-recipients of an e-mail message. Statistics objects exist to reflect the summary of interactions for each relationship and for each entity over all of his/her relationships. Therefore, statistics objects are anchored from relationship objects and entity objects, respectively. Relationship value objects represent the value of each relationship attribute (e.g., longevity, complexity) and the overall strength of the relationship between two entities.

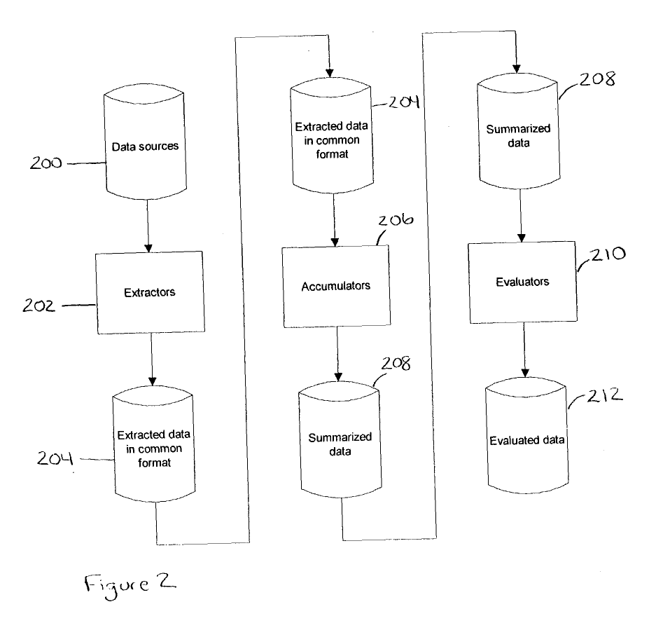

As shown in FIG. 2, the architecture of the system comprises three components: extraction, accumulation, and evaluation. These components can be run separately or in combination, though sequentially. The first component, extraction component 202, reads the various data sources 200 (e.g., e-mail messages and calendar events) in their natural format and extracting the relevant data (e.g., senders and recipients of an e-mail message, participants of a meeting) and storing it in a common format per data source 204. This way, for example, no matter what mail system or calendar system the data comes from, the resulting data is of a common format. The second component, accumulation component 206 examines this extracted data 204 to detect entities (e.g., people) and relationships and to create or update data constructs 208 representing entities and relationships, as well as accumulating the overall usage statistics for entities and the interaction statistics for the entities involved in relationships. The third component, evaluation component 210, retrieves this summarized data 208 and calculates the strength of the relationships between entities. Relationship strength is a relative measure, and the strength of an entity's relationship is relative to all his other relationships.

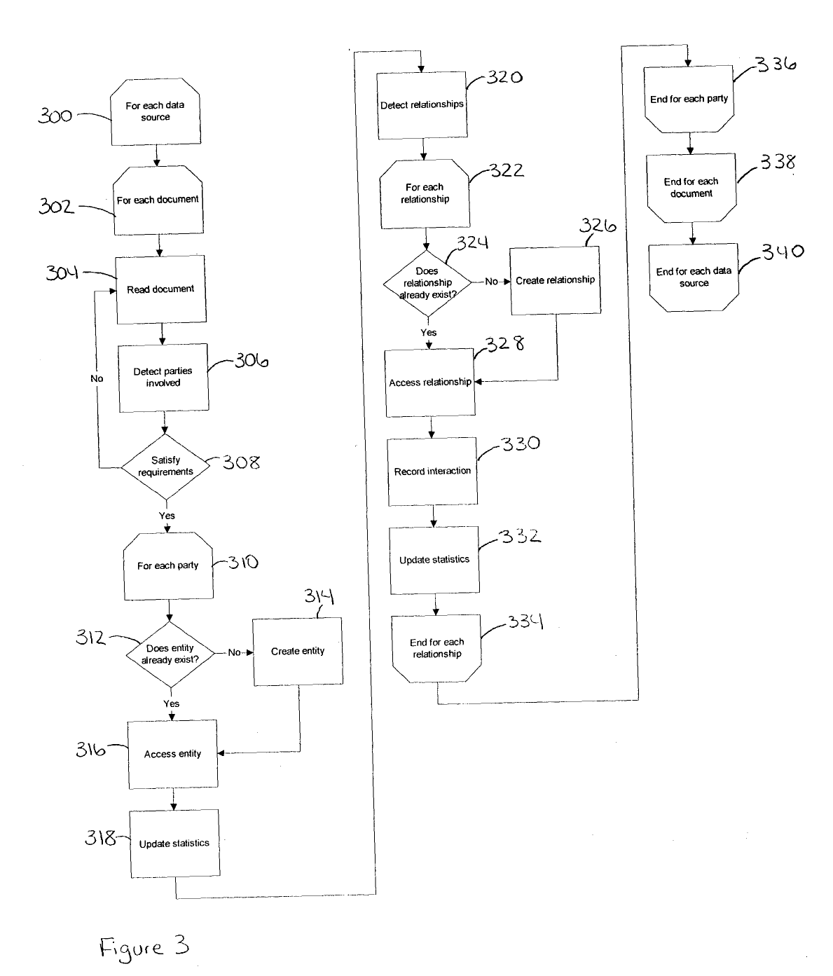

FIG. 3, is a flow diagram for the accumulation component 206. Each document 302 within each data source 300 is read. The parties within each document are identified 306 after the document is read 304. A determination is made as to whether the document satisfies the necessary requirements 308 (e.g., no e-mails to a large mailing list). If the document satisfies the requirements 308, a determination is made as to whether each party 310 already exists 312 as a persistent data construct within the system. The entity objects associated with each party are accessed. If any party does not yet have an associated entity object, one is created 314 for it. The entity is then accessed 316 and the statistics are updated 318. Next relationships among the entities are detected 320. For each relationship 322 the invention checks if the relationship is new 324. For newly detected relationships 324, a persistent data object for the relationship is created 326. The invention accesses the relationship 328 and the interaction for the detected relationship is recorded 330 (e.g., the date of the interaction) as well as accumulated (e.g., total number of interactions, total number of one-on-one interactions). Additionally, statistics for an entity over all his relationships are also maintained 322. The end of each processing loop (relationship, party, document, and source) is shown as items 334-340.

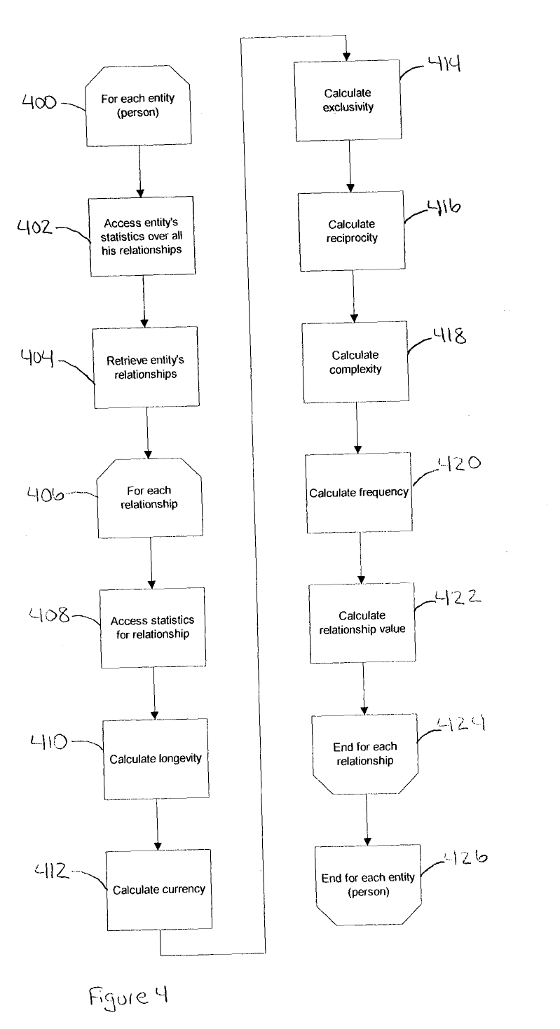

FIG. 4, is a flow diagram for the evaluation component 210. Each entity 400 of the system is accessed 402 along with its overall statistics. Each one of the entity's relationships 404 is also accessed along with its statistics. The overall statistics for an entity as well as the statistics for the relationship 406 involving the entity are used as input to the relationship algorithms. Each relationship algorithm calculates 410-420 a relationship value for its respective relationship attribute. Relationship values range from 0-1, with 1 signifying the strongest.

The value of the longevity 410 of the relationship between two people, from the perspective of the first entity, is determined by taking the ratio of the date of the earliest entry with the second entity with the date of the earliest entry over all the first entity's relationships. The value will be between 0 and 1. The relationship value of longevity 410 would be 1 if, given the recorded data, the date of the first interaction with the second entity is the earliest interaction of the first entity.

The value of the currency 412 of the relationship between two people, from the perspective of the first entity, is determined by taking the ratio of the date of the most recent entry with the second entity with the date of the most recent entry over all the first entity's relationships. The value will be between 0 and 1. The relationship value of currency would be 1 if, given the recorded data, the date of the last interaction with the second entity is the most recent interaction of the first entity.

One measure of exclusivity 414 between two people is the ratio of one-on-one interactions over total interactions. From the perspective of the first entity, the value of exclusivity is this ratio for the relationship between the first entity and the second entity compared to this ratio for all the relationships of the first entity. The relationship value of exclusivity would be 1 if, given the recorded data, the ratio of exclusivity between the first and second entity is greater than or equal to all of the other relationships of the first entity.

The value of reciprocity 416 of the relationship between two people, from the perspective of the first entity, is a measure of how bidirectional the correspondence between the two entities is compared to all of the other relationships of the first entity. The relationship value of reciprocity would be 1 if, given the recorded data, the ratio of correspondence sent/received between the first entity and the second entity is greater than or equal to all of the other relationships of the first entity.

The complexity of a relationship 418 is a measure of the areas of interaction, the times of interaction, and the levels of interaction. Areas of interaction measure the number of PIM sources used by the entities of a relationship to interact with each other (e.g., do they just correspond by e-mail or do they also meet). Its relative value, from the perspective of the first entity, is expressed as a percentage over the maximum number of areas that the first entity uses to interact with any other entity.

Times of interaction measure the business and personal interactions of the entities of a relationship by the times of their interaction (e.g., do they just meet during business hours or do they also meet on weekends). Its relative value, from the perspective of the first entity, is expressed as a percentage over the maximum number of interaction times that the first entity interacts with any other entity. Levels of interaction measure the distinct groups associated with the second entity as seen by the first entity. Its relative value, from the perspective of the first entity, is expressed as a percentage over the maximum number of groups associated with any other entity interacting with the first entity. A value is calculated for each one of these measures of interaction. These interaction types can also be weighted to indicate greater importance, etc. Therefore, the total value of complexity of a relationship is the sum of these weighted values.

The data required for frequency type calculations 420 include the following fields: the originator, the target, and the date of interaction. The date of interaction could also be changed to a time range, with the addition of a field to track the number of interactions within that time range. From this data, a planar chart could be constructed with normalized time values as the x-axis and a normalized interaction count as the y-axis.

The x origin represents the date of the earliest interaction and the x end point represents the date of the most recent interaction (normalized to one). (An alternate could also be applied, letting the x end points represent the end points of a time range and ignoring any communications outside that time range). The x axis can then be divided into equally spaced partition. The number of interactions occurring between those submissions are summed, and that sum is then entered as the value at the appropriate place on x. The y origin starts at zero and proceeds to the largest sum value computed above (then again normalized to one). The normalization allows later computation of areas and slopes to produce values in the range of 0.0 to 1.0.

There are a number of values, including but not limited to frequency, that can be obtained from this data and chart. Frequency (or Activity) Trend which fits a straight line and computes the slope of that line. Projected Frequency fits a line and finds the intercept at a certain x value.

Overall Frequency either takes the average value of the sample points or finds the area under the curve. Weighted Frequency creates a new graph where the sample points are multiplied by a weighted average curve, then applies the Overall Frequency calculations (this is good for giving higher precedence to recent relations). Low/High Points fit a polynomial curve and computes relative maximum and minimums. Constancy averages deviation at sample points from the computed Overall Frequency.

A relationship value is calculated for all relationship attributes 422. The end of the loop for each relationship and person is shown as items 424, 426. These relationship attributes can also be weighted to indicate greater importance, etc. Therefore, the total relationship value is the sum of these weighted values.

The overall attribute information of all the relationships of a given user can be used to create a user's social network map represented as a graph. The graph can be used to make useful inferences such as the shortest path or the best path from the user to a particular person in their social network map. The user's social network is that subgraph of the organization's social network that contains all nodes and edges that are on any path that includes the user's node. Furthermore, the best path could be classified as a specific type of path. For instance it could be a “personal” or “professional” or “authoritative” best path where each edge of the path falls within this category. The resulting social network graph could have directed or undirected edges. If external data, for instance organizational chart data, is available, then directed edges can be constructed that follow hierarchical constraints. Next the invention describes the formulas and algorithms for computing the shortest path and best path. In this description, the invention uses the following notation.

G=graph representing a social network. G=(V,E) where:

V={v}=the set of vertices (nodes) in G. Each node v corresponds to a person.

E={e}=the set of edges in G. The presence of an edge between two vertices indicates the existence of a relationship between the two corresponding people.

W={w}=the set of weights corresponding to the edges in E. The value assigned to w is between 0 and 1, where 0 corresponds to no relationship and 1 corresponds to a very strong (high quality) relationship.

p=a path in G. A path is a sequence of nodes connected by edges.

e{k,p}=k-th edge of path p.

w{k,p}=weight of k-th edge of path p

|p|=the length (no. edges) of path p

e{|p|,p}, w{|p|,p}=the last edge of path p and its weight

w{min,p}, w{max,p}, w{avg,p}=the minimum, maximum and average edge weight of path p.

The shortest path between two people (nodes) is simply that with which the fewest people/relationships (nodes/edges) must be traversed. This can be computed using a standard shortest-path algorithm such as Dijkstra's (Introduction to Algorithms, The MIT Press, p. 527-531). For the shortest-path calculation, which ignores the quality of relationships, all edge weights w are set to 1. Shortest paths with particular constraints, such as directed edges that respect hierarchical constraints, could be constructed. Specifically, in this context, each node can contain information about which level of a hierarchy the person belongs to. A default, user-editable constant, maxDeltaH can be defined and set to represent the maximum permissible difference in the hierarchical levels of the two vertices of an edge. If the difference in the hierarchical levels, deltaH, of a relationship in a potential shortest path is larger than maxDeltaH then that path is discarded and alternate shortest paths can be sought.

The invention defines the “best path” to be the path that will be best when used to specify a sequence of introductions from the user to the person the user wants to meet for some reason such as getting expert advice. The measure of the quality of a path for this purpose should favor short paths while favoring large edge weights. It is not sufficient, however, to look only at the total edge weight of a path. It is desirable for all the relationships (edge weights) to be of adequate quality; thus special attention should be paid to the lowest quality relationship w{min,p} in a given path. The last relationship w{|p|,p} is also important since it forms the final direct link to the destination node.

Specifically, the best path algorithm should satisfy the following four criteria, the first two of which are expressed as constraints. (1) The best path should satisfy w{|p|,p}>w{avg,p}. That is the weight of the last edge (link to final destination node) of a path should be greater than the average edge weight of the path. (2) Shorter paths (smaller values of |p|) should be favored, and should be subject to the following constraint: For paths p2 and p1 where |p2|>|p1| only consider p2 (over p1) if w{min,p2}>w{avg,p1} and w{k,p2}>[w{avg,p1}+qk], where q, is some constant. If q>=1 then this second condition subsumes the first. In other words, when comparing two paths p1 and p2, where |p2|>|p1|, that are of different lengths, the weight of each edge of the path that is longer, say P2, should be greater than some threshold value. This value could be initialized to w{avg,p1} the average edge weight of path p1. Then, as each edge, e{k,p2}, of p2 is considered, the edge weight should be greater than (w{avg,p1}+(q)(k)) where q is some constant that has a default value equal to 0.1 but can later be modified on the basis of empirical data. The value of q should be selected bearing in mind that the maximum permissible edge weight on a given path is 1. It should be calculated such that the expected weight of each e is not larger than 1.

In other words, if a longer path is being considered, then each of its edges should have a “better” weight than the edges of the shorter path. Therefore a longer path, for instance p2, should have a higher edge weight for edge e{k,p2}, where k is the path length from the source node of p2 to the edge e{k,p2}, and that weight must be directly proportional to k. (3) Paths with larger values of w{min,p} should be favored, all else being equal. (4) Paths with larger values of w{avg,p} should be favored, all else being equal.

A variety of methods could be designed that would address these criteria in different ways. The invention suggests three different objective functions for this purpose. The first two do not address the first two criteria (the constraints) directly but rather address the same underlying issues by a certain weighting of the appropriate path attributes.

One possible objective function (O(p)) for best path algorithm is O(p)={exp[a(1−|p|)]}[bw{|p|,p}+cw{min,p}+dw{avg,p}], where p is the path, |p| is its length, w{|p|,p} is the weight of its last edge, w{min,p} is the weight of its minimum-weight edge and w{avg,p} is its average edge weight. The symbols a, b, c and d are parameters satisfying a>0, 0<b<1, 0<c<1, 0<d<1 and b+c+d=1.

Another possible objective function (O(p)) for best path algorithm is O(p)={exp[a(1−|p|)]}[w{|p|,p}\hat{ }bw{min,p}\hat{ }cw{avg,p}\hat{ }d], where “x\hat{ }y” means “x raised to the power y” and the parameters a, b, c and d have the same constraints as above. Using this product form has the advantage that (for example) w{min,p}=0 means that O(p)=0. Note that taking the logarithm of this function yields a function that is linear in the path length |p| and linear in the logarithms of all the associated path attributes w{|p|,p}, w{min,p} and w{avg,p}.

The above two functions include factors that are negative exponential functions. The longer the path, the smaller the effect, in absolute terms, of the other attributes (other than |p|) on the objective function. Another possibility is to use the following objective function O(p)=|p|−[bw{|p|}+cw{min}+dw{avg}], with some constraints. This approach involves some initial filtering and sorting. The objective function is computed through the following steps. First, exclude any paths with a zero-weight edge and any path that fails the first constraint of w{|p|,p}>w{avg,p}. This ensures that all paths considered have large last edge weights, thus ensuring strong relationships with the destination node. Secondly, let A_{G}=w{avg,G}, the average edge weight of an entire social network graph. Let A_{P}=w{avg,P}, the average edge weight of all paths being considered for the current best path. If (A_{G}−A_{P})>t, where t is some threshold value, then simply consider the shortest path as the best relationship path. It is not worth considering edge weights in this case since most of the edge weights are below a threshold, A_{G}. Exclude the following steps if this condition is true. Third, by sorting paths in order of decreasing [bw {|p|,p}+cw{min,p}+dw{avg,p}]. The higher the value of this function, the better the quality of the path. Finally, sort paths in order of increasing |p|, while maintaining the previous order for all paths with the same |p| value, and then apply the third criteria for the objective function as follows.

For each group of constant-length paths compute p_ma(n)=max_{p||p|=n}[w{avg,p}]. That is the maximum average-edge-weight over all those paths. Then compute p0(n)=max_{m<n} p_ma(m), which means the maximum average edge weight over all edges of all paths of length less than n. Further, the invention eliminates any paths that fail to satisfy: w{min,p}>p0(n) and w{p,k}>[p0(n)+(q)(k)], where q is some constant. This leaves a set of paths that (a) satisfy all the four constraints and (b) are first in order of increasing length and then, (c) within each set of constant length, sorted in order of decreasing [bw {|p|,p}+cw{min,p}+dw{avg,p}]. If the constraints are handled separately, the final ordering corresponds to using an objective function of: O(p)=|p|−[bw {|p|}+cw{min}+dw{avg}] as long as the w's are between 0 and 1, c and d are between 0 and 1 and c+d =1. This is valid because |p| can only be an integer value and [cw{min}+dw{avg}] is between 0 and 1. With this O(p) smaller values are obviously better.

A relationship between two people can be defined in terms of the following attributes: longevity, currency, reciprocity, exclusivity, frequency, and complexity. The longevity refers to how long the two parties have been connected. Currency refers to the recency of the connection. Reciprocity is a function of the mutual interchange between the parties. Exclusivity is a function of the number of one-on-one interactions and the privacy of the interactions. Frequency is a measure of the rate of interactions. Complexity is a function of the levels and the context of the interactions.

The raw data of the PIM data sources named above can provide clues to detect whether a relationship between two people exists and to qualify that relationship. Events record the past, present, and future scheduled activities of people. The parties of an event (e.g., organizers and participants) indicate those involved with the activity and may also demonstrate a relationship between the parties. That is, an organizer and each participant may have a relationship. Additionally, each participant may have a relationship with each other. An event with just two participants may imply a more exclusive relationship between the participants than an event with many participants. An event with a large number of participants (as in a conference setting or a large meeting) may have no significance on the relationships among the participants. The participation role indicates whether a participant is required, optional, copied just for informational purposes, or is to chair the event. Participants who are just copied for informational purposes are less likely to attend the event and therefore may offer no significance to the quality of the relationship.

This invention describes a system that extracts data from several daily life sources to build a social network of its users based on their interactions with others. Some aspects of this invention are providing a definition of a relationship (see attributes above), discovering that a relationship exists between two people, qualifying that relationship (i.e., defining its value), given the defined relationship attributes, dynamically building a social network based on these discovered relationships, and calculating the shortest and best paths through the social network, given the quality of the relationships.

With a social network mapped from all the individual relationship structures, individuals can quickly view their directly connected relationships as well as paths to approach others. Since the social network is weighted based on the quality of the relationships, the best path between any two individuals is easily identifiable. When other attributes, such as expertise, are mapped onto our social network, the system can be applied to other applications for locating the optimal paths to experts, for example. The social network can also be used to spread information efficiently through an organization. It can also be used as a tool for viral marketing. Additionally, by the use of articulation points, key intermediaries can be identified. An organization can use the social network to monitor inter/intra departmental communication, and institute corrections (e.g., promote external relationships) as necessary.

Additional aspects of this invention are its use of primary data sources, that by the definition of their function (e.g., a calendar), provide a wealth of current and accurate information, without the added burden on its users to create artificial entries. The invention can also qualify connections between people (e.g., this is a complex relationship), rather than just quantify them (e.g., a relationship exists because the parties have had n meetings). The invention can find the best path through this relationship social network, rather than just the shortest path.

While the invention has been described in terms of preferred embodiments, those skilled in the art will recognize that the invention can be practiced with modification within the spirit an scope of the appended claims.

What is claimed is:

1. A method of identifying relationships between users of a computerized network, said method comprising:
extracting relationship information from databases in said network, said information comprising at least one of address book information, calendar information, event information, to-do list information, journal information, and e-mail information; and
evaluating said relationship information to produce relationship ratings of said users of said network.

2. The method in claim 1, further comprising at least one of:
determining a level of reciprocity of relations between different users;
determining a longevity of relations between said different users;
determining how current relations are between said different users;
determining a frequency of relations between said different users;
determining a level of exclusivity of relations between said different users; and
determining a level of complexity of relations between said different users.

3. The method in claim 1, further comprising evaluating whether a user is a direct or indirect correspondence recipient as reflected by said e-mail information.

4. The method in claim 1, further comprising evaluating times of events and users involved in events to establish relationships between said users.

5. The method in claim 1, further comprising evaluating time of day of one of event and e-mails to establish whether a relationship is personal or business related.

6. The method in claim 1, wherein said evaluating further comprises weighting at least two of said address book information, said calendar information, said event information, said to-do list information, said journal information, and said e-mail information differently to calculate said relationship ratings.

7. A method of identifying relationships between users of a computerized network, said method comprising:
extracting information from address books in said network; and
evaluating said information to produce relationship ratings of said users of said network.

8. The method in claim 7, wherein said evaluating comprises determining whether one or both of different users have the other user in their address book to establish a level of reciprocity of relations between said different users.

9. The method in claim 7, wherein said evaluating comprises determining a time of first creation to establish a longevity of relations between said different users.

10. The method in claim 7, wherein said evaluating comprises determining a time of a last access to establish how current relations are between said different users.

11. The method in claim 7, wherein said evaluating comprises determining how often two or more users communicate to establish a frequency of relations between said different users.

12. The method in claim 7, wherein said evaluating comprises determining the number of affiliations to establish a level of complexity of relations between said different users.

13. A method of identifying relationships between users of a computerized network, said method comprising:
extracting e-mail communications information between users of said network; and
evaluating said e-mail communications information to produce relationship ratings of said users of said network.

14. The method in claim 13, further comprising evaluating whether a user is a direct or indirect correspondence recipient of an e-mail message.

15. The method in claim 13, further comprising evaluating a time of day of users sent said e-mail transmission to establish relationships between said users.

16. The method in claim 13, wherein e-mail communications information comprises information indicating recipients of an e-mail message.

17. A program storage device readable by machine, tangibly embodying a program of instructions executable by the machine to perform a method of identifying relationships between users of a computerized network, said method comprising:
extracting relationship information from databases in said network, said information comprising at least one of address book information, calendar information, event information, to-do list information, journal information, and e-mail information; and
evaluating said relationship information to produce relationship ratings of said users of said network.

18. The program storage device in claim 17, wherein said method further comprises at least one of:
determining a level of reciprocity of relations between different users;
determining a longevity of relations between said different users;
determining how current relations are between said different users;
determining a frequency of relations between said different users;
determining a level of exclusivity of relations between said different users; and
determining a level of complexity of relations between said different users.

19. The program storage device in claim 17, wherein said method further comprises evaluating whether a user is a direct or indirect correspondence recipient as reflected by said e-mail information.

20. The program storage device in claim 17, wherein said method further comprises evaluating times of events and users involved in events to establish relationships between said users.

21. The program storage device in claim 17, wherein said method further comprises evaluating time of day of one of event to establish whether a relationship is personal or business related.

22. The program storage device in claim 17, wherein said evaluating further comprises weighting at least two of said address book information, said calendar information, said event information, said to-do list information, said journal information, and said e-mail information differently to calculate said relationship ratings.
